(19) United States
(12) Patent Application Publication
(10) Pub. No.: US 2015/0081581 A1
(43) Pub. Date: Mar. 19, 2015

(54) SECURE DELIVERY OF PACKAGES

(71) Applicant: Zzzoom, LLC, Boca Raton, FL (US)

(72) Inventor: Kayle Gishen, Boca Raton, FL (US)

(73) Assignee: Zzzoom, LLC, Boca Raton, FL (US)

(21) Appl. No.: 14/031,578

(22) Filed: Sep. 19, 2013

(51) Int. Cl. G06Q 10/08

(52) U.S. Cl. CPC G06Q 10/083
USPC 705/330

(57) ABSTRACT

Delivering packages among a community of participants is carried out using a computer. Software stores information pertaining to senders, couriers, and receivers, including their images. Information is additionally stored pertaining to the package, including a description, an image of the contents, and geographic locations where the package is to be picked up and delivered. A picture of the courier is taken when she is physically in the presence of the sender, and the computer compares this image to the stored image to confirm the identity of the courier. An image of the receiver is similarly compared, and the images of the contents are compared. The GPS coordinates of the pickup and delivery are compared with previously agreed upon locations. Participants are notified if images or coordinates do not match.

### FIELD OF THE INVENTION

The invention relates to a system and method for securing delivery of packages where the participants in the delivery transaction are not known to each other, and more particularly for using computer recognition to increase the security and trust within the transaction.

### BACKGROUND OF THE INVENTION

WIPO application WO 2011054710 to Apthorp discloses announcement of information for pickup and/or delivery of physical objects by a courier device to the customer device, wherein a courier device sends a first electronic calendar information to the customer device, and wherein the customer device replies an automatically generated reply message with a suggestion to an alternative pickup and/or delivery time through a second electronic calendar information.

U.S. Pat. No. 7,983,991 to Crussol discloses associating a good unique identifier (GUID) to a package comprising the physical goods requested by a client, obtaining proof of identity parameters from a client associated with the transaction involving the physical goods before the delivery of the physical goods, where the proof of identity parameters are provided to the client by a trusted authority.

U.S. Pat. No. 6,892,939 to Nguyen discloses processing packages where a package is received at an intermediate shipping site and a delivery authorization status corresponding to the package is determined. The package is delivered if the authorization status is that the delivery is acceptable and the package is not delivered if the authorization status is that delivery is not acceptable.

### SUMMARY OF THE INVENTION

In accordance with an embodiment of the disclosure, a method for delivering packages among a community of participants comprises using at least one computer executing software stored on non-transitory media, the software configured to—store information pertaining to a plurality of participants, including an image of participants who are senders, couriers, and receivers; store information pertaining to a participant who is a sender of a package, a participant who is a receiver of the package, and a selection of a participant who is courier to deliver the package; store information pertaining to the package, including a description of the contents of the package, a first geographic location where the courier is to pick up the package, and a second geographic location where the courier is to deliver the package; receive a first image of the courier, the first image taken when the courier is physically in the presence of the sender to pick up the package; compare the first image of the courier with a stored image of the courier among the images of participants; notify at least one of the receiver and the seller if the first image of the courier does not match the stored image of the courier; receive an image of the receiver, the image taken when the receiver and the courier are physically in each other's presence for the courier to deliver the package; compare the image of the receiver with a stored image of the receiver among the images of participants; notify at least one of the sender and the courier if the image taken of the receiver does not match the stored image of the receiver; receive information pertaining to a delivery geographic location of the package when the package and the receiver and courier are mutually physically present for delivery of the package; compare the delivery geographic location with the second geographic information; and notify the sender if the delivery geographic location does not match the second geographic location.

In an embodiments thereof, the software is further configured to receive an image of the sender when the courier is physically in the presence of the sender to pick up the package; compare the image of the sender with a stored image of the sender among the images of participants; and notify at least one of the courier and receiver if the image taken of the sender does not match the stored image of the sender.

In another embodiment thereof, the software is further configured to receive a second image of the courier, the second image taken when the receiver and the courier are physically in each other's presence for the courier to deliver the package; compare the second image of the courier with a stored image of the courier among the images of participants; and notify at least one of the sender and the receiver if the second image of the courier does not match the stored image of the courier.

In further embodiments thereof, the software is further configured to receive a first image of the contents of the package before the courier takes possession of the package for delivery; receive a second image of the contents of the package when the receiver and the courier are physically in each other's presence for the courier to deliver the package and compare the first image of the contents with the second image of the contents and notify at least one of the sender and the receiver if the first and second images of the contents do not match.

In a yet further embodiment thereof, the first image of the contents of the package is received when the sender and the courier are physically in each other's presence for the courier to pick up the package.

In another embodiment thereof, the software is further configured to receive a geographic pickup location of the package when the package is picked up by the courier for delivery; receive a geographic delivery location of the package when the package is delivered to the receiver; and cause the geographic pickup and delivery locations to be available electronically by at least one of the sender and receiver.

In still further embodiments thereof, at least one of the geographic pick up and delivery locations are GPS coordinates; the software is further configured to compare the geographic pickup location with the stored first geographic location, and notify at least one of the sender and receiver if the geographic pickup location does not correspond to the first geographic location; the software is further configured to compare the geographic delivery location with the stored second geographic location, and notify at least one of the sender and receiver if the geographic delivery location does not correspond to the second geographic location; the software is further configured to debit an account of at least one of the sender and receiver for a fee for the courier to deliver the package; the fee for the courier is based upon the historical reliability of the courier in performing deliveries; the fee for the courier is further based upon the dimensions and weight of the package, and the distance over which the package must be delivered; the fee for the courier is further based upon the number of deliveries made by the courier; the fee for the courier is determined as a function of the historical reliability of the courier weighted by a factor, and the number of deliveries made by the courier, weighted by a factor.

In a further embodiment thereof, the stored image of participants is obtained from a digital image of an official identity card of the participant; the software is further configured to identify a plurality of facial features from the stored image of participants; and compare the plurality of facial features with a plurality of facial features of other received images of the participants.

In another embodiment thereof, the other received images of the participants include at least one of the first image of the courier, the image of the receiver, an image of the seller when the seller and the courier are physically mutually present, and an image of the receiver when the receiver and the courier are physically mutually present.

In a further embodiment of the disclosure, a system for delivering packages among a community of participants, comprises at least one computer executing software stored on non-transitory media, the computer including—a storage device for storing information pertaining to a) a plurality of participants, including an image of participants who are senders, couriers, and receivers; b) a participant who is a sender of a package, a participant who is a receiver of the package, and a selection of a participant who is courier to deliver the package; and c) the package, including a description of the contents of the package, a first geographic location where the courier is to pick up the package, and a second geographic location where the courier is to deliver the package; a network device for receiving a) a first image of the courier, the first image taken when the courier is physically in the presence of the sender to pick up the package; b) an image of the receiver, the image taken when the receiver and the courier are physically in each other's presence for the courier to deliver the package; c) information pertaining to a delivery geographic location of the package when the package and the receiver and courier are mutually physically present for delivery of the package; a processor for comparing a) the first image of the courier with a stored image of the courier among the images of participants; b) the image of the receiver with a stored image of the receiver among the images of participants; c) the delivery geographic location with the second geographic information; and a communication device for notifying a) at least one of the receiver and the seller if the first image of the courier does not match the stored image of the courier; b) at least one of the sender and the courier if the image taken of the receiver does not match the stored image of the receiver; and c) the sender if the delivery geographic location does not match the second geographic location.

In another embodiment of the disclosure, a method for delivering packages among a community of participants, comprises using at least one computer executing software stored on non-transitory media, the software configured to—store information pertaining to a plurality of participants, including an image of participants who are senders, couriers, and receivers; store information pertaining to a participant who is a sender of a package, a participant who is a receiver of the package, and a selection of a participant who is courier to deliver the package; store information pertaining to the package, including a description of the contents of the package, a first image of the package contents, a first geographic location where the courier is to pick up the package, and a second geographic location where the courier is to deliver the package; receive a first image of the courier, the first image taken when the courier is physically in the presence of the sender to pick up the package; compare the first image of the courier with a stored image of the courier among the images of participants; notify at least one of the receiver and the seller if the first image of the courier does not match the stored image of the courier; receive an image of the receiver, the image taken when the receiver and the courier are physically in each other's presence for the courier to deliver the package; compare the image of the receiver with a stored image of the receiver among the images of participants; notify at least one of the sender and the courier if the image taken of the receiver does not match the stored image of the receiver; receive a second image of the contents of the package, the image taken when the receiver and the courier are physically in each other's presence for the courier to deliver the package; compare the stored first image of the package contents with the second image of the package contents; notify at least one of the sender, the courier, and the receiver if the first image of the package contents does not match the second image of the package contents; receive information pertaining to a delivery geographic location of the package when the package and the receiver and courier are mutually physically present for delivery of the package; compare the delivery geographic location with the second geographic information; and notify the sender if the delivery geographic location does not match the second geographic location.

### BRIEF DESCRIPTION OF THE DRAWINGS

A more complete understanding of the present invention, and the attendant advantages and features thereof, will be more readily understood by reference to the following detailed description when considered in conjunction with the accompanying drawings, wherein:

FIG. 1 is a graph depicting a typical public transit route of the PRIOR ART;

FIG. 2 depicts an ideal fully connected graph representing all possible routes when integrating public and private transit in accordance with the disclosure;

FIG. 3 depicts a least transfers route using the system of the disclosure;

FIG. 4 depicts an illustrative computer system that may be used to carry out the disclosure;

FIG. 5 depicts a sender and courier authenticating each other;

FIG. 6 depicts the sender and courier of FIG. 5 storing an image of a package contents;

FIG. 7 depicts the courier departing with a closed package;

FIG. 8 depicts the courier and a recipient authenticating each other;

FIG. 9 depicts the courier presenting the package to the recipient;

FIG. 10 depicts the receiver storing an image of the package contents for comparison with the sent contents;

FIG. 11 depicts capture of a participant identification, and parsing of information, including facial features of the participant for later comparison; and

FIG. 12 depicts a measurement of performance of participants, and an impact on fees earnable by the participants.

### DETAILED DESCRIPTION OF THE INVENTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The terms “a” or “an”, as used herein, are defined as one or more than one. The term plurality, as used herein, is defined as two or more than two. The term another, as used herein, is defined as at least a second or more. The terms “including” and “having,” as used herein, are defined as comprising (i.e., open language). The term “coupled,” as used herein, is defined as “connected,” although not necessarily directly, and not necessarily mechanically.

Public transit includes all manner of transportation for one or more people where the people would not normally decide the route, time of departure, and many other aspects of the trip. Often, public transport is controlled by a government or quasi-government entity. Private transit includes walking and using vehicles whose departure time and route are under the control of the people traveling. Additionally, private transportation is not generally made available to all who wish to use it, whereas public transportation is generally available to all.

More specifically, private transit tends to exclude passengers who cannot afford the use or ownership of a private vehicle, particularly where the journey is far. While public transit is affordable for most passengers, the network availability, or the selection of routes and times is necessarily limited, and does not adequately provide for the needs of all who wish to travel inexpensively.

In accordance with the disclosure, public transit resources, or the public transit grid, is combined with private transportation to provide a more complete set of options for passengers wishing to obtain the flexibility of private transportation at a cost much closer to the cost of public transportation, or less than private transportation alone, particularly in consideration of the cost of ownership of a private transport vehicle.

Further in accordance with the disclosure, passengers are provided with a set of route instructions which includes information pertaining to available public transport, as well as private transport that is made available through the use of a system 100 of the disclosure. In this manner, a greater extent of route coverage is made available, as well as more flexible timing.affordable. Further, by making private transportation more generally available, a quasi-public transportation network is created with far greater coverage and flexibility than a conventional public transportation network.

System 100 of the disclosure creates a mixed mode transit wherein a passenger can travel using both private and public transit to achieve a better traveling experience. System 100 provides one or a plurality of routes for a passenger optimized for the least time, the least transfers, and possibly the least cost. System 100 integrated a public transit route with multiple private transit options using a graph search function of the disclosure. The search uses tiered path planning to offer routes determined to be optimal by the heuristic of the disclosure that is used to determine the optimal path.

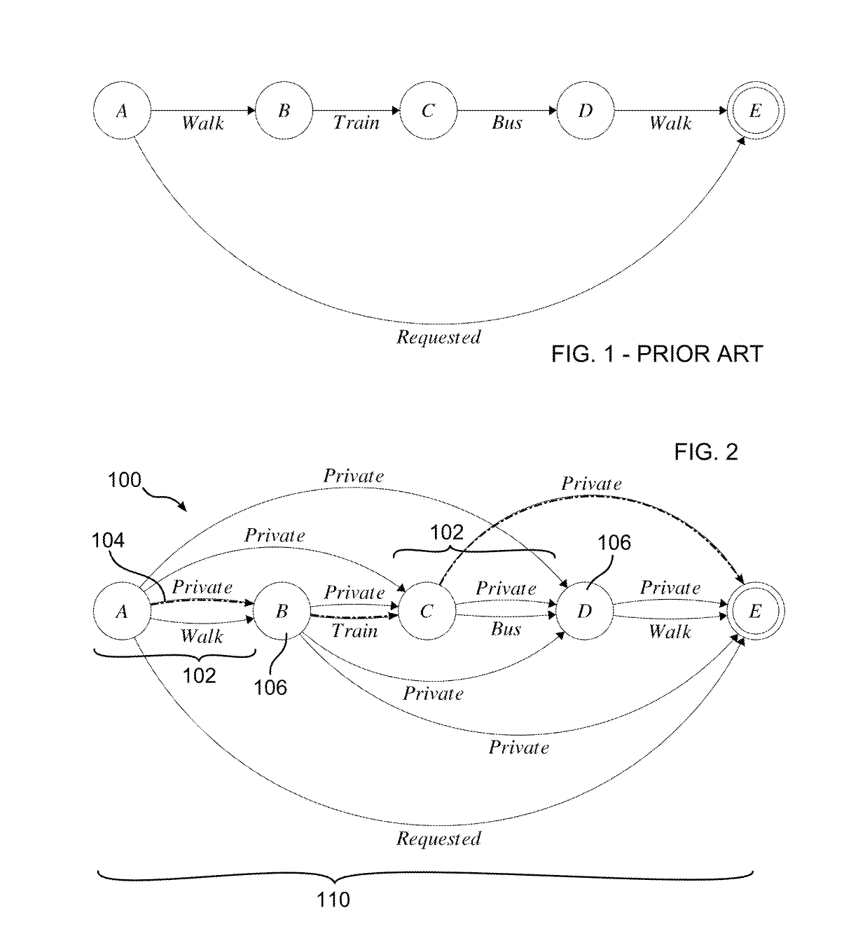

With reference to FIG. 1, a typical prior art public transit route is represented as a graph where each node is a point along the route (A-E), the nodes are joined by connecting arrows representing various forms of travel, including ‘Walk’, ‘Train’, and ‘Bus’. A travel leg 102 includes a node or waypoint 106 and an arrow extending to the next waypoint 106. A route is a series of one or more legs 102. An example route 104 is illustrated as a dashed line, in FIG. 2. A series of possible routes to a destination is a map, or result set 110.

In accordance with the disclosure, in view of a graph methodology, an original edge, corresponding to a public or private leg, is replaceable, and the graph remains monotonic, directed, and acyclic when new edges are inserted. More particularly, monotonic pertains to enforcing that the path between any two nodes is always moving the user closer to their destination. A replaceable edge is one where the filter is satisfied, and will generally be a long duration edge. A non-replaceable edge is one where a shorter duration replacement is not likely, for example a subway transfer, where the waiting time is generally short and the travel time is also short.

In accordance with the disclosure, and with reference to FIG. 2, system 100 integrates edges or legs 102, into an optimized result set 110 comprising a plurality of routes 104. A route 104 is any combination of legs 102 which advances the passenger from an origin, depicted in FIG. 2 as waypoint “A”, to a destination, depicted as waypoint “E”). Legs 102 are filtered by a filter 108, based on a Δₜ and Δₓ, representing a change in duration and distance, respectively, each factor limited by a threshold waiting time value. Filtering is used to foster the selection of transfers, or changes in transport mode at waypoints 106, when required, that are simple or uncomplicated for a passenger to carry out, such as a subway transfer within a city, while optimizing the route set 110 as a whole. More particularly, where a simple transfer can be used, one or more relatively more complex transfers can be discarded, reducing the size of the total set of possible legs.

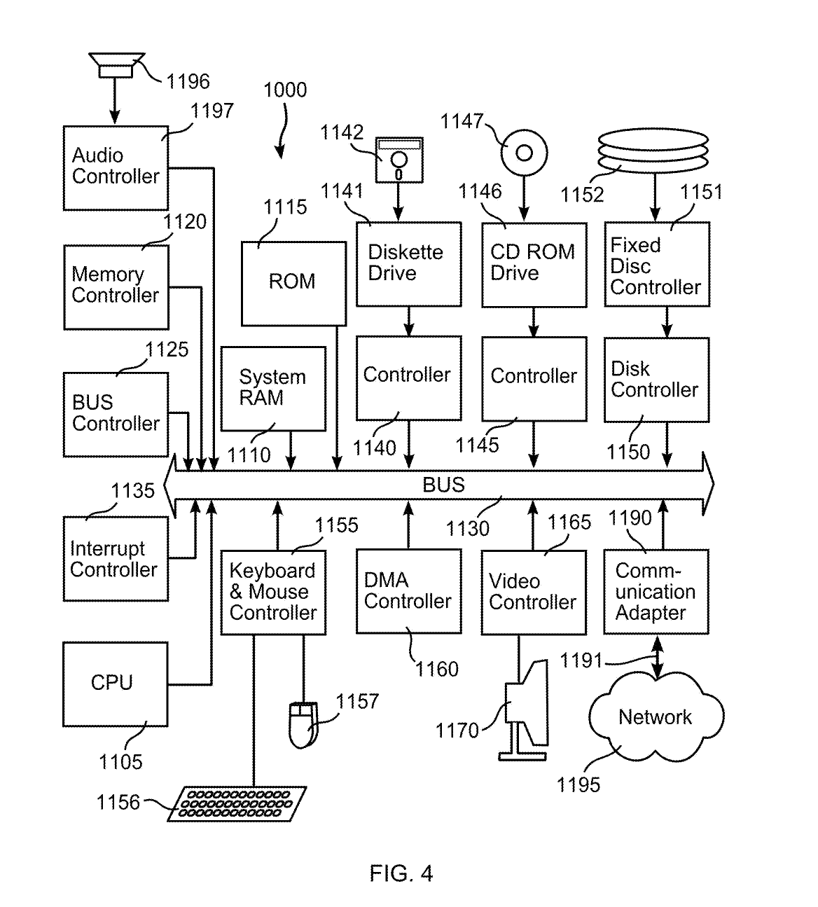

It should be understood that system 100 comprises one or more computers 1000 (FIG. 4) executing software stored on non-transitory media. The calculation of routes combining all modes available, including public and private transport nodes, is understood to be impossible for humans to do in real time, as passengers stand by for an initial set of routes, or for the calculation of route changes during trips. This is particularly true for traveling in cities or between towns and cities, where there are many transport options. Further, as described in additional detail below, private transport is identified by inviting participants controlling private transportation resources to contribute those resources, for example to offer providing rides to passengers. These invitations and contributions are created using the internet, or any other computer based network, and can include using the cellular network and smartphones, in addition to other forms of computing resources. It is contemplated that system 100 performs these calculations, together with invitations for private transport, for the route planning of at least hundreds or thousands of travelers at a given time.

In the instant disclosure, a driver is a person who owns, operates, or controls a private vehicle not normally hired as a taxi or other vehicle principally hired out and licensed chiefly for this purpose. In the context of the instant application, while a driver may make money or obtain other benefits from volunteering their vehicle within system 100, it is generally considered that this is an ancillary purpose for the vehicle, and the vehicle is not principally used as a taxi, limousine, bus, or the like.

Further in accordance with the disclosure, private transportation services from drivers is crowd-sourced using an offer and bid model, in which drivers who have registered with system 100 can volunteer their services to drive passengers, and passengers can bid on the seats made available in this manner. Crowdsourcing as defined in Wikipedia is the practice of obtaining needed services, ideas, or content by soliciting contributions from a large group of people, and especially from an online community, rather than from traditional employees or suppliers. In the context of the instant disclosure, crowdsourcing specifically includes passengers and drivers using system 100 to offer or seek available seats.

Driver's engaged in the use of system 100 can accept a passenger bid if they find any or all of the following to be satisfactory: monetary compensation, departure time, seats required, length of route, passenger identity, including gender and age, and other information. In accordance with a further aspect of the disclosure, drivers are compensated with the transfer of credits purchased in whole or in part by passengers, advertisers, operators of system 100, government agencies, employers, schools, philanthropists, family members, or others. Drivers can convert credits into monetary compensation using system 100. In this manner, passengers and drivers do not need to exchange cash, or use credit cards, increasing the safety of all participants.

In one embodiment, the cost of a ride using private transport is based on its distance. As bids do not have to have the same starting and ending points as an original driver's offer, the bid price may differ from an original offer. In another embodiment, passengers submit requests for rides to system 100, and drivers bid to transport the passengers. In this embodiment, passengers search for transport to a destination using system 100, for example using a website or cellphone application embodying portions of system 100. In response, system 100 provides transport routes that include private, public, and integrated public and private results. A passenger may then make a request to system 100, using the website or application. Drivers, also using the website or application, can then submit bids to provide the private portions of the transport route.

When a passenger or driver specifies a route or destination, they include a time span when the route is needed or available, the number of seats that are need or can be provided, and the beginning and end points desired or available, respectively. This is provided when requesting and offering a bid. When a bid is accepted, the starting and ending points of the route are assigned to the winning bidder. If the route is integrated, the bids are automatically placed for the passenger. If a bid is not accepted by any driver, a route that is entirely public is presented to the passenger.

System 100 receives continuously updated information pertaining to public routes from the public transport providers, and from private services that monitor such public routes. Because the set of all possible public transport routes within a geographic area can be vast, calculating public or integrated routes can be processor intensive and complex, and could not be carried out manually in a sufficiently timely manner to produce a timely and useable result. Further, it is challenging and expensive to carry out the calculations using computer servers in a timely and cost effective manner, as well. Accordingly, in accordance with the disclosure, to reduce processing time and costs, a subset of all public transport possibilities is used in a typical route analysis for a passenger. This subset represents known popular or reliable public routes, the size of the subset targeted to correspond to available processing power and reasonable time constraints, e.g. an amount of time that a passenger or driver will wait for a result. Private transit results may then be correlated with the selected subset by joining graphs in accordance with the disclosure. If there are many private results, these too may be limited by similar criteria, for similar reasons.

FIG. 2 illustrates a result set 110 of possible routes 104, each route 104 comprised of one or more legs 102. The result set 110 may have eliminated some non-simple transfers due to filter 108, and thus the result set does not show all theoretical routes 104. In FIG. 2, the waypoints 106, are the same as depicted in FIG. 1, but in accordance with the disclosure, each waypoint 106 in FIG. 2 is connectable by a set of a plurality of legs, the legs representing the simplest modalities from a passenger's perspective, as clarified by filter 108. FIG. 2 thus integrates a set of travel choices into a single map or result set 110, where each node is connected by at least one theoretically viable transport mode. In subsequent steps, it is determined if each mode is in fact predicted to be available at the required time. This real time availability will likely further reduce the set of available leg choices in subsequent steps.

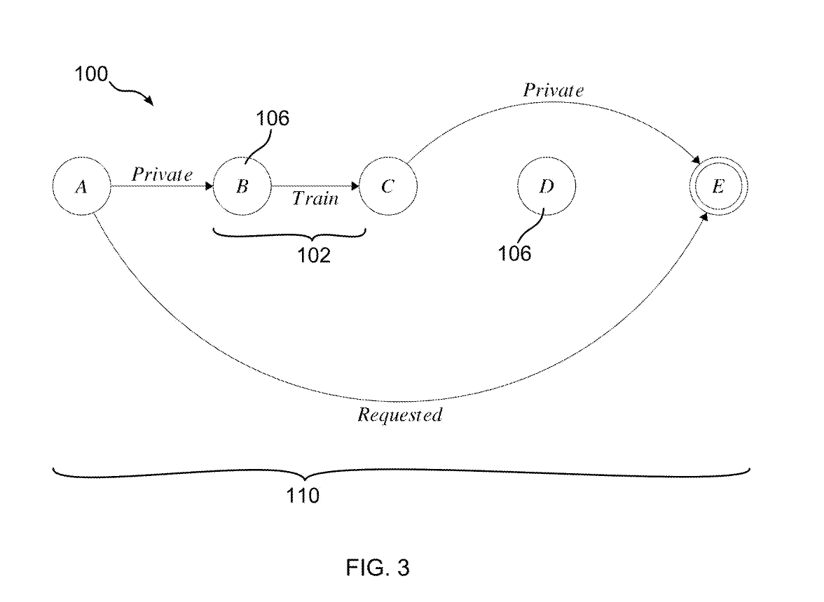

FIG. 3 shows a possible route. The route is achieved through the use of a graph search algorithm, which can include for example A*, Dijkstra's Algorithm, and Breadth-First Search (BFS) strategies, although other strategies may be used. When searching the ‘graph’, (herein a map), for possible result set 110 of possible routes, the ‘edges’ (herein legs 102), between each ‘node’ (herein stops or transfers) are weighted specifically for the type of leg 102. Weighting is based on factors impacting the relative merits of each leg 102, such factors including, for example, most progress, least transfers, fastest, and least expensive. When determining the least transfers route, the BFS strategy can be used without any edge weighting, as the algorithm will naturally provide an optimal solution.

As can be seen from FIG. 3, six legs 102 of the result set 110 have been removed, leaving route 104, which has been determined to be the most direct and simple route for the passenger. In the case of fastest (least time), the weights could be the time required to complete the leg combined with the amount of time a passenger would be stationary at one point. This may be calculated in accordance with Formula 1 of the disclosure, as follows:

w=ntₚ(+*)(tₘ)^{x} where n and x are constant, x<1, and tₚ, tₘ are time waiting and time moving, respectively.

Formula 1 emphasizes the time a passenger will be waiting, while simultaneously reducing the weight on movement time. Thus, as long as the passenger is moving, an important optimizing requirement is satisfied, however consideration must also be given to time in motion.

In accordance with an alternative embodiment of the disclosure, x can be a combination of tₚ, tₘ, for example tp/tm, in order to satisfy x<1, as opposed to a constant. This change causes the optimization to factor in time waiting versus time traveling, while still optimizing total time.

The foregoing weighting heuristics of the disclosure replace the distance metric generally used in A*. Since each waypoint is at a fixed coordinate, use of the standard implementation of A*, which is Manhattan or Euclidean, would result in the same result as BFS. The use of Formula 1 provides a more accurate and useful result than using Manhattan or Euclidean heuristics.

If at any point a route 104 determined using public or private transit results in a significant waiting period at a public transit node, for example the passenger arrives early with respect to a departure time, a second public transit search can be conducted, and the resultant second public transit graph is tiered, or reintegrated into a new result set of routes for the passenger. The two original public transit graphs can be isolated, yet each joined with the same or different private transit options. The routes found from the initial result set are compared with the new result set. Typically, the second result set is an improvement upon the least time route of the first result set. This tiering integration can continue until all significant pauses in movement are reduced.

Further in accordance with the disclosure, a result set 110 is provided diagrammatically, or routes 104 can be presented as a list of directions, for the passenger. The diagram and or directions enable the user to select from at least one viable route 104. In one embodiment, a passenger can customize a given route 104 by changing a leg 102, for example removing a a private leg 102, resulting in presenting the one or more public transportation modes previously determined. For example, a passenger can continue to change one or more legs 102 designated private transport to public transport legs, until a completely public transit route 104 is generated. In another embodiment, a user can request that one or more public transport legs 102 of a route 104 be replaced by private transport. If no simple or efficient private transport legs 102 are available, an inefficient private transport leg 102 could then be substituted.

In accordance with the disclosure, it is thus possible to combine public transportation options which do not form a complete path between an origin and a destination, because the one or more gaps therebetween can be filled by private transport. More particularly, multiple public transit graphs are joined, and new nodes or waypoints are created where there is no overlap. These new waypoints are then connected by private transit. An example process is illustrated in Example 1, which follows.

### EXAMPLE 1

### Route Generation Process

A passenger seeks transportation from Palo Alto, Calif. to San Francisco, Calif. System 100 analyzes all available private offers starting in Palo Alto and ending in San Francisco, and returns these immediately to the user. The system then analyzes public transit information, generally using a subset of all possibilities that is likely to be satisfactory to a passenger, for example based upon popularity, ratings, or previous selections by this passenger or a set of passengers. Once the routes are identified, the route request input is parsed, and a graph data structure is assembled. For ease of understanding, in the following example only one public transportation route results, consisting of four legs:

1 Walk from Origin in Palo Alto to bus stop A.

2 Take bus B to train station C.

3 Take train D northbound to San Francisco station E.

4 Walk from train station E to the Destination (˜10 mins).

Next, system 100 matches available offers from drivers for any of the four nodes, and finds the following result set of two offers:

1 Offer #1: From Origin in Palo Alto to train station C.

2 Offer #2: From train station C in San Francisco to the Destination (˜2 mins)

These two offers are added to the graph data structure.

Next, system 100 performs the graph search. Using a standard BFS approach, the least-transfers route is returned:

1 Accept Offer #1 to train station C.

2 Take train D northbound to station E.

3 Either walk or accept Offer #2—due to the nature of BFS, both satisfy the route and either can be chosen. The internal structure of the graph and the BFS algorithm will determine the outcome, which may not be the optimal result for the passenger.

Next, system 100 performs an A* graph search as modified in accordance with the disclosure. The suggested route is as follows:

1 Accept Offer #1

2 Take train D northbound

3 Accept Offer #2

Here we can see that the final leg has a deterministic outcome. Using the modified A* and a simple case where Offer #2 starts as the train arrives, consideration of the duration causes the driving in Offer #2 to be favored, as it is faster than walking.

The two integrated results are transformed back into instructions from the graph structure, with each private leg containing a reference to the public legs it replaced. In the A* case, this would be represented as follows:

1 Accept Offer #1
or (a) Walk to bus stop A,
   (b) Take bus B to train station C

2 Take train D northbound to San Francisco station E

3 Accept Offer #2
or (a) Walk to destination

These instructions are then sent to the passenger. The passenger can then remove any of the private transit offers, resulting in the original public transit route. Once satisfied with the choices made, the user can save the route. If the route contains private transfer offers, the system then makes all needed private transit bids on behalf of the user. When it is time for the ride to commence, if a private transit bid has not been accepted, or private transfer availability has not otherwise been confirmed, the user will see the corresponding public transit results again.

In accordance with the disclosure, an optimal route satisfies both a predetermined minimum time requirement and a predetermined least transfers requirement simultaneously, or is otherwise acceptable to the passenger. System 100 attempts to find the shortest travel time which requires the least (fewest) transfers. An optimal route may not satisfy a predetermined criteria for absolute least transfers, but may be faster, or conversely may satisfy least transfers, but require a longer travel time.

In an embodiment, a passenger can use a computing device to enter a natural language request, whether typed or spoken. Natural language processing is carried out by computer 1000 using a variable context compiler 1020 (not illustrated). Compiler 1020 employs a first method which uses certain keywords and keyphrases to determine the meaning of successor text by using grammar rules which are correlated to a position of the keywords and keyphrases within the text. This first method captures specific patterns that are likely to have specific meaning based upon a specific grammatical order.

Compiler 1020 can additionally or alternatively employ a second method in which the order of keywords or keyphrases within the text is not a primary factor for interpretation. By removing a requirement for keywords and keyphrases to occupy a particular position within the text, and by interpreting phrases regardless of a specific grammatical order, a more flexible set of input text may be processed. In an embodiment, the first and second methods are combined, and the results are analyzed together using variable context compilation. This enables greater flexibility in the scope of language which can be understood by system 100.

In one embodiment, compiler 1020 uses a grammar which is more rigid than context free, but not as rigid as a context aware. This is achieved by specifying a tiered grammar that matches as specifically as possible, while simultaneously removing positional constraints. Variable context compiler 1020 parses L1 to LN grammars simultaneously. For example, the presence of a natural date (ex. Saturday) would match an L1 grammar rule to set the date. A modifier could be matched as well (ex. next); however, this would be part of an L2 grammar as the successor could be a day of the week or month. A complex match would be the LN* case. In this there may or may not be a triggering keyword at the beginning of the pattern, but there must be a capturing keyword within or at the end of the pattern. An example would be “from? STRING* to STRING*”. In this case the word ‘from’ is optional, but the word ‘to’ must be present. To determine the beginning and end of the variable length ranges (STRING*) is where the elimination of the positional constraint is seen. Parser 1020 will match as much as possible, then through other rules remove overlapping and nested matches, as the tiered rules become more specific. In accordance with an embodiment, variable context compiler 1020 includes combining a sliding window filter with cascade architecture, where the cascade modifies the match instead of simple rejection testing.

The foregoing is illustrated with the following example.

### EXAMPLE 2

### Parsing Natural Language

The following inputs can be typed in, spoken then converted to text, or provided to a server forming a part of system 100 by any other means.

Input 1: “Palo Alto to San Francisco at 9 am”

Input 2: “leave at 9 am to San Francisco from Palo Alto”

Using a standard linear compiler, both inputs require two different sets of grammar rules, as compilation occurs in the order that terms are presented. This method is inefficient in that each possible order of terms requires a new rule. Conversely, the number of rules increases for combination of terms allowed. Exemplary rules used by a linear compiler, for these inputs, follow.

Rules for Input 1:

START “to” END
GARBAGE
TIME

Rules for Input 2:

GARBAGE
TIME
“to” END
“from” START

where GARBAGE is a rule stating the token can be discarded.

In accordance with the disclosure, the positional constraints are removed, and a cascade of rules is introduced. Accordingly, a single set of rules can process both inputs, as follows.

INPUT -> STRING_GROUP “to” STRING_GROUP
STRING_GROUP -> STRING_GROUP “from” STRING_GROUP
STRING_GROUP -> STRING_GROUP + TIME
GARBAGE

It may be seen that Input 1 is first parsed into two STRING_GROUP portions. The first portion is analyzed and is provisionally taken as the start. The second portion matches for a time and returns the time portion and the remaining tokens.

For Input 2, the two STRING_GROUP portions are different. The first portion contains the time and the second portion contains both a start and an end. The second rule is cross matched with the first rule, and the start is confirmed. The remaining location can then be taken as the destination.

While this example is simple, it illustrates the manner in which both inputs generate the same output using one set of rules in a cascade style compiler of the disclosure. The compiler has four rules which can be applied to a plurality of inputs, whereas a standard linear compiler needs seven rules to address the same two inputs. Further, a standard linear compiler must try both sets of rules, resulting in double the compilation processor work, whereas the compiler of the disclosure carries out a single set of rules. Moreover, for each change in input order, a standard linear compiler needs an additional set of rules, and must perform an additional compilation; however, the compiler of the disclosure remains at one set of rules, and carries out a single compilation.

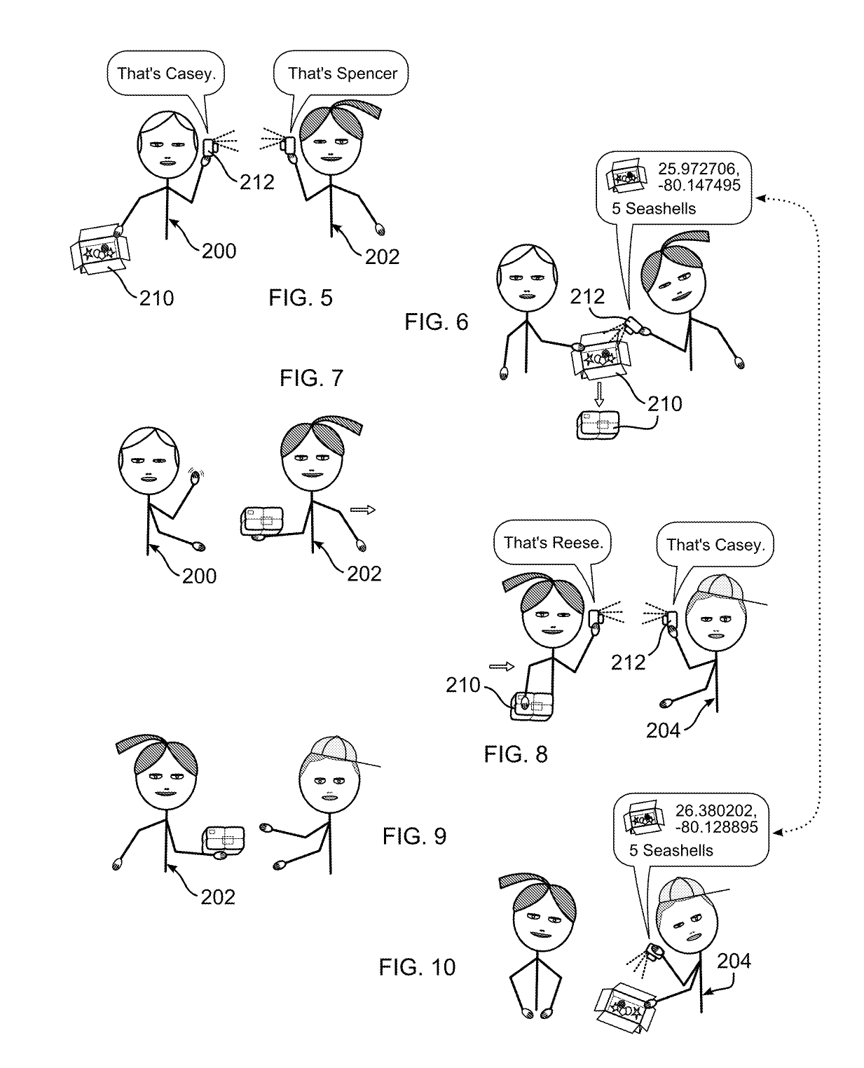

With reference to FIGS. 5-10, a process for trusted delivery of packages 210 using private individuals or crowdsourced resources is disclosed. This process has certain functions of a courier service, but includes elements which increase the trust level associated with all participants, which typically include a sender 200, a courier 202, and a recipient 204. The courier can use the route planning methodology described hereinabove, using a mix of private and public transport, as described. For valuable packages, however, it may be expected that the courier has private transportation of their own. In either event, the methodology described herein for causing an introduction of participants, determining trustworthiness, and causing payment, apply to the process of providing courier services. An alternative process is further described as follows.

With crowdsourcing, in particular, people in direct interaction with, and reliance upon, each other need to have a minimum level of mutual trust. This minimum threshold may be established by the value or urgency of the package to be delivered, for example. This trust can be hard to acquire, especially for newly introduced individuals. The disclosure provides a system and method for establishing and fostering trust through the use of technology and an interaction of the virtual and physical world, addressing the aspects of identity, security, and reliability.

In FIG. 5, a sender at left, called Spencer, takes a photo of a courier, Casey. The photo, is advantageously in digital format natively, and is compared by a computer processor with one or more other digital photos of Casey made available to the computer processor previously, as described further below. If the newly obtained digital image of Casey is deemed by the processor, and optionally also by Spencer, to be that of Casey, Spencer can conclude that Casey is present.

If Spencer is using a smartphone 212, he can use it to obtain the digital photo, and to perform the comparison of the various images of Casey. This reduces waiting time, as there is no immediate requirement to upload the newly obtained image. The comparison image can be downloaded earlier, as soon as the identity of the courier has been determined. In an embodiment, the newly obtained photo of Casey is transmitted to a server, for example using the internet or a cellular network, where a remote server carries out the comparison. In either event, Spencer's smartphone advises Spencer if the image taken of Casey matches the one or more stored images of Casey. If Spencer does not have a smartphone, the image can be input into a separate computer which can either carry out the comparison, or transmit the image for comparison by a remote computer.

Likewise, Casey the courier takes a digital photo of Spencer the sender, and an identical procedure takes place, in which a computer processor advises Casey if the new image of Spencer matches one or more stored images of Spencer. If either Casey or Spencer are satisfied that they personally recognize the other, the process of image comparison can be omitted in that case. It should be understood that the sender and receiver may mutually agree that it is only necessary to authenticate the identity of one of either the sender or the courier, in which case only that participant's image is captured and compared with a stored image of the participant.

Once the sender and the courier are satisfied as to the identity of each other, the sender can either provide the package to the courier, or can increase the trust level of the transaction as follows. With reference to FIG. 6, a photo of the package contents is made in the presence of the sender and the courier. In the illustration, Casey takes the photo, as she is responsible for delivering the actual contents. However, it is only necessary that the participants are satisfied that a photo is provided which accurately reflects the package contents. The photo can also be made prior to the courier's arrival by anyone, and the courier can be shown the photo if desired by the participants. It is advantageous, from a security and trust standpoint, for the image to be made before the courier takes possession of the package for delivery.

The photo can be transmitted to the recipient, and is also made available to the sender and if desired, the courier. Cloud storage can be used to share the image, or any other known means, including a usb drive or other storage media. If the participants agree, it may not be necessary to view or photograph the contents of the package. In some instances, for example, the description, dimensions, and weight may be sufficient, depending upon a trust level among the participants.

In addition to an image of the package contents, GPS coordinates or other locator is associated with the image, together with an adequate description of the contents. The detail of the description is dependent on the value and the needs of the participants, and can be terse, or extremely detailed. In accordance with an embodiment, the image taken of the package contents, together with the location and description data, is transmitted to the recipient, Reese, prior to arrival of Casey. In this manner, Reese can validate that the package contains the contents sent by Spencer. For this reason, cloud sharing is advantageous, as the courier has no opportunity to change the information before it is received by the recipient.

Once the image and description have been obtained, the package is closed. For valuable packages, any one or more of the participants may wish the package to be well secured, and/or sealed with a tamper resistant closure. This process is advantageously completed in the presence of both Spencer sender and Casey courier, after which Casey can leave with the package (FIG. 7), with an obligation to deliver the package within a predetermined time period. One or more additional photos of the sealed package can be included in the transmission to Reese receiver, to provide an additional level of security and trust. As is customary, the courier would typically be responsible for reasonable care of the package, including protecting it from damage, theft, or tampering.

In FIG. 8, Casey courier meets Reese receiver, and if not satisfied that they know each other, take each other's picture as described with respect to FIG. 5. In this case, one or more processors compare the newly taken photos with existing images to determine if there is a match for each of the courier and receiver. As in FIG. 5, each participant can also compare the individual before them with previously stored images, and can also consider information associated with the image, such as the age, gender, and any other descriptive information. In some cases, the participant's may agree that only the receiver or courier's identity must be authenticated at this point.

Once identities are established, Casey courier surrenders the package to Resse receiver in FIG. 9. Reese can then open the package, and as shown in FIG. 10, photograph the contents as described with respect to FIG. 6. The image and description are compared with the image and description generated in FIG. 6. This comparison can be carried out by either or both of the sender and the receiver, and/or by one or more processors and/or sensors which compare the contents before being sealed and given to the courier, and when opened at the receiver. Any known or hereinafter developed means of comparing the contents of the package at each location can be employed, including sensors for detecting gases, object recognition software, electronic testing, and measurements by microscopy, weight, color, and dimensions, and electronic signaling devices, including RFID or other tags or electronic identification, for example.

A GPS location or other location information is associated with a validation of the description and image in FIG. 10, and this information is transmitted back to Spencer sender to confirm delivery of the correct contents, at the correct location. Reese can further take a picture of himself and the contents, possibly with Reese, to provide further assurance to the sender that the package was delivered to the intended recipient.

Various steps can be omitted, in accordance with the disclosure, although the level of trust and security drops accordingly. For example, it is not necessary for the package contents to be inspected when given to the courier, or when given to the receiver, or for the photographic process associated with the procedure to be carried out. However, this usually would be the case only after the participants have established a sufficient level of trust in one another. Notwithstanding this, inspection and photography remains important to be sure one is not inadvertently transporting illegal materials. In the example of FIGS. 5-10, seashells are delivered, which normally would not be illegal. However, in some locales, it is illegal to collect seashells, and therefore, participants may sometimes need to rely on the reputation and knowledge of the sender and recipient. For this reason, the reputation of the participants remains important, as described further herein.

While it is beneficial to know everyone involved in a delivery transaction, this will not be possible in many cases, and particularly with crowdsourcing. While a background check could be carried out, and may be logical for highly sensitive or valuable packages, this often may not be practicable. An ID issued by a trusted authority can be used as a commonly existing resource for providing members with the ability to join and start participating in a crowdsourced package delivering community within minutes.

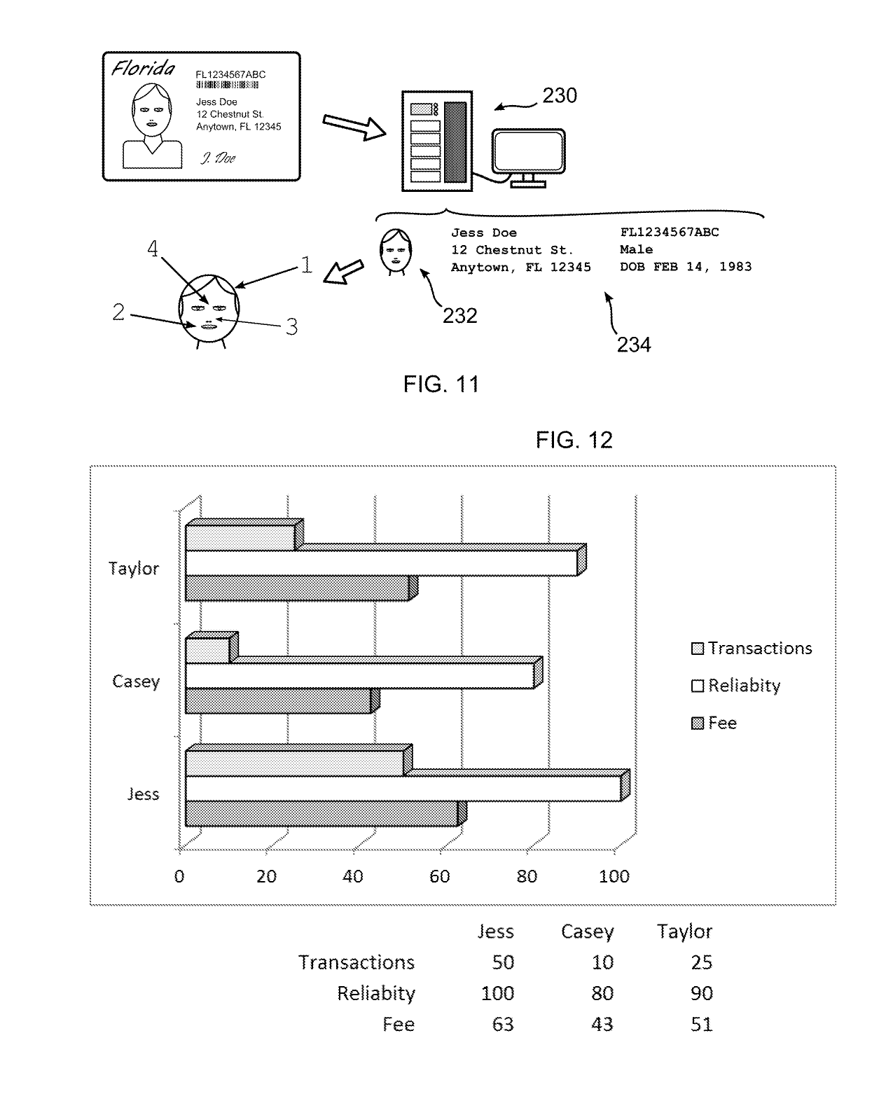

With reference to FIG. 11, when a sender, courier, or receiver wishes to participate in the package delivery process of the disclosure, he or she uploads to a computer 230 a digital image, taken for example with a digital camera or a scanner, of an official identity document. Examples include a state driver's license, a federally issued ID card, or national passport. Computer 230 can be a computing device of the user, for example a desktop, laptop, tablet, or smartphone, executing software of the disclosure. Alternatively, computer 230 can be a server accessible to the internet or another network. Either a user's computer, or a networked computer, then analyzes the ID, extracting an image of the user's face 232, as well as address, age, birthdate, gender, and other identifying information 234. This information is used to authenticate the user as described with respect to FIGS. 5 and 8.

In an embodiment, security is improved if computer 230 is not under the control of a participant, and/or is not accessible or manipulable by a member of the transaction or the public, except insofar as computer 230 can accept uploads, and particularly secure uploads of images. In this manner, computer 230 can be considered a trusted resource by all participants.

To aid in computer implemented face recognition, carried out in FIGS. 5 and 8, an image extracted from the official identity document is pre-processed to facilitate and accelerate a subsequent comparison with the image obtained in FIG. 5 or 8. For example, a face image is found upon the ID during a primary stage, using facial detection. This image is then processed for a feature set in a secondary stage, in which any skew angle and rotation is removed. Once the image is oriented, certain features, indicated symbolically in FIG. 11 as references 1-4, are identified and stored for comparison. When images are obtained during the process of FIGS. 5-10, they can be processed in a similar manner, and the results compared with the image from the official identity document.

In an embodiment, information and images associated with the official ID, as well as information pertaining to past performance of users, membership information, fee information, and other user profile information, is stored in one or more administrative servers operating under a management organization. The organization includes managers, salespeople, technical support, engineers, and other specialists can maintain the administrative servers, and develop and enforce rules and procedures for all users, including suppliers, couriers, and receivers, and their agents. The organization promotes the proper and safe use of a system in accordance with the disclosure which carries out the procedures described herein.

Referring again to FIGS. 5 and 8, in particular, each user can obtain an image of another user they are transacting with. This image is compared with an official ID image of the other user, to determine if the person with whom they are transacting is factually the person they are representing themselves to be. Whether recognition is accomplished by a remote server, or the user's computing device executing software provided by the management organization, the comparison of images is simplified in that the image does not need to be compared against many images in order to determine a match, but rather, the newly obtained image must merely be determined to match a user who's identity has been established as part of the delivery transaction. Accordingly, it may be sufficient that a limited set of common features between the official ID image and the newly captured image must match, for example two features. Of course, fewer or additional features can be compared, based upon the value of the package being transported, and other security considerations.

To decrease false rejections, the pattern matching algorithm used to compare images can be very sophisticated, including algorithms which can remove glasses or other appurtenances, for example. The algorithm can be very strict in its implementation, requiring a match for numerous features. However, such implementations cause an increase in false rejections. Conversely, too liberal an implementation can cause a false acceptance. For each application, a reasonable balance can be determined. In an embodiment, the strictness of the required match can be related to the value and security considerations associated with the package and the transaction participants. If the images are determined not to match, the process can be attempted again with another picture, the transaction can be terminated, or the users can elect to proceed anyway, for example based upon their own comparison of an official ID presented by the user before them.

In an embodiment, a unique authentication code, for example a PIN code, can be associated with a computer authentication of a participant, and can be given to the participant for whom the authentication was requested, by the authenticating computer system. The requesting participant can then insert this authentication code into a database record completed as part of the transaction, thereby enabling confirmation within a process of the disclosure that the photographic authentication procedure was completed successfully.

In an embodiment, some or all of the images captured of users or participants are stored by the administrative server. These images can serve as alternative images for comparison, either by a computer performing the comparison, or by people doing so. Similarly, data obtained pertaining to transactions is stored, and can be analyzed, to increase efficiency, accuracy, and reliability of the package delivery process. For example, performance of each participant can be statistically monitored. Factors monitored can include timeliness, courtesy, efficiency, reliability, accuracy, and payment performance. Some of these factors can be judged by other users/participants, and some or all of this data can be made available to some or all other users, so that informed judgments can be made about participants, for example in terms of selecting fellow participants for a delivery transaction.

As noted herein, the GPS location, or other location information is captured during the delivery transaction (FIGS. 6 and 10). This information can be checked on the internet by participants, to be sure the package was received and delivered at the correct locations. Additionally, this information can be checked by administrative servers against previously entered data, to be sure the transaction is taking place as agreed by the participants.

In instances where either the sender or recipient or both are not present, the transaction can proceed if all participants (including the absent sender or receiver) wish to continue. In this event, all other aspects of the transaction as described in FIGS. 5-10 can nonetheless be carried out. For example, a proxy, or designee can obtain and compare the courier's face image, and can also present the opened package for inspection and photography, and seal the package. To the extent such an agent fulfills the role of a participant, they are deemed to be the participant, for purposes of interpreting this disclosure. A proxy can perform similar functions at the receiving step. In addition, if there is sufficient trust among the participants, any one or more of the described steps can be omitted. In these instances, checks are still performed by the administrative server, and alerts can be issued directly to the sender or receiver by the administrative server. For example, an alert can be sent indicating an image of a party taken during the transaction does not match the stored official ID for the correct participant, or the GPS coordinates are not as agreed upon. In this event, the seller or receiver can remotely indicate that the transaction should terminate, or they can take such other action as may be appropriate.

The disclosure addresses, at least, identity, security, and reliability. However, a measure of reliability can only be created by carrying out transactions. To encourage users to reliably assume their responsibilities in a transaction, including timely appearance and proper delivery, a compensation system can be implemented which rewards reliability, among other attributes. With reference to FIG. 12, a notional example is illustrated for three participants, any of which are measured for their performance as seller, courier, receiver, proxy/agent, or any combination of these roles, although each role can be measured and reported separately. A fee is calculated based upon factors associated with the transaction.

For example, a fee can be determined based upon the weight of the package, the dimensions of the package, the distance to transport the package. Additionally or alternatively, a participant can be measured in terms of their reliability and the number of deliveries or transactions in which they've participated. In the example of FIG. 12, a fee conversion is calculated as (reliability*x)+(# of transactions*y), with x=0.5 and y=0.25. This is merely an example, however, and a fee calculation can be substantially more complex, or substantially simpler. Moreover, the example of FIG. 12 does not consider weight, dimensions, distance, contents value, contents fragility, contents hazards, or other parameters, any of which can be factored into the fee separately. Rather, FIG. 12 is provided to illustrate that a fee earnable can be related to a users experience with the system and process of the disclosure, as well objective and subjective measurements of their reliability. The values of x and y selected are arbitrary in this example, but are provided to indicate that experience and reliability can be assigned different weights. Further, other weightings can be used, and all weightings and factors can be adjusted for all users over time.

The fee conversion can represent a virtual currency, not directly redeemable outside the authority of the management or other organization. Once a fee conversion reflecting reliability and experience, and any other factors, is determined, the result can be converted into a real world fee in currency which is redeemable by the participant who earned the fee. In another embodiment, the fee conversion is directly equivalent to currency. In an embodiment, the fee conversion is adjusted to reflect a reasonable compensation, which can be adjustable based upon the type and value of the selected currency. Whether or not the fee conversion is equivalent to real currency, it is a virtual currency until its value is finally realized or determinable, and it is made redeemable as currency, for example as a credit on a credit card. By using a virtual currency, the need to exchange cash or otherwise carry out a final payment during the transaction can be avoided. For example, all fees due to a participant during a month can be paid once per month, reducing an overall transaction cost, and greatly simplifying transactions overall.

In an embodiment, many potential couriers in a crowdsourced community can view a proposed delivery, for example using a website of the management organization. Those potential couriers who are interested in carrying out the delivery for the sender and recipient can bid for the work. Their bid can represent their converted fee at the time of submitting the bid. In this manner, it is generally understood by the other participants that the cost of the courier will be proportional to their reputation for experience and reliability, as well as other factors. In an alternative embodiment, couriers can propose a lower bid for work they would be willing to carry out for a lower fee than their ranking would entitle them to Likewise, couriers can bid a higher price for work which they deem difficult or undesireable. Through the use of a crowdsource community, senders and or receivers can choose couriers based upon a wide variety of factors, including the preferences of the couriers submitting bids. Either the sendor or the receiver can select a courier. Typically, the participant selecting the courier will pay the fee, although other participants can pay, as mutually agreed.

By including subjective measurements, including for example opinions and rankings, and objective measurements, including numerical measurements which can be captured by people or computers, a participant's fee conversion can result in a greater or lesser payment rate for their work. In an embodiment, a fee conversion weighs more heavily the failure to perform all of a certain type of work at an acceptable level, against exceptional work for a subset of all agreed tasks. The fee conversion can reward a user who not only completes their agreed task, but does so with exceptional performance, and likewise reduces compensation for poor performance.

It should be understand that, herein, a match or correspondence between images or geographic locations means that the compared items match with reasonable certainty. For items of low value or importance, the level of certainty is lower than for items of high value or importance. Accordingly, a perfect match or correspondence is understood to be only theoretically possible, and that a reasonable match or correspondence is that which uses an amount of time, computing power, and accuracy of source images or data which is commensurate with the value or importance of the package contents, and the level of security and confidence desired by the participants.

Through the use of the system and process described herein, identity of participants can be established, and a measure of security can be realized. Further, a physical exchange of a package or other goods or product can be carried out using a virtual exchange of money, thereby increasing security within the transaction. Further, the disclosure enables the use of a crowdsourced community to carry out services which would otherwise only be provided by established commercial vendors of satisfactory reputation.

It should be understood that a package, in accordance with the disclosure, can also include a document or any other token, including a form of identification. In this manner, the disclosure can be used to authenticate individuals. Alternatively, no taken can be exchanged, and/or no courier can be required. In this embodiment, individuals are authenticated to each other using the process of the disclosure. More particularly, individuals can mutually present themselves, take each other's picture, and use computers to authenticate the new picture against one or more stored pictures, including using historically captured images and historical authentication data.

Exemplary Computer System

FIG. 4 illustrates the system architecture for a computer system 1000, such as a process controller, or other processor on which or with which the disclosure may be implemented. The exemplary computer system of FIG. 4 is for descriptive purposes only. Although the description may refer to terms commonly used in describing particular computer systems, the description and concepts equally apply to other systems, including systems having architectures dissimilar to FIG. 10. Computer system 1000 can control temperatures, motors, pumps, flow rates, power supplies, ultrasonic energy power generators, and valves, using actuators and transducers. One or more sensors, not shown, provide input to computer system 1000, which executes software stored on non-volatile memory, the software configured to received inputs from sensors or from human interface devices, in calculations for controlling system 200.

Computer system 1000 includes at least one central processing unit (CPU) 1105, or server, which may be implemented with a conventional microprocessor, a random access memory (RAM) 1110 for temporary storage of information, and a read only memory (ROM) 1115 for permanent storage of information. A memory controller 1120 is provided for controlling RAM 1110.

A bus 1130 interconnects the components of computer system 1000. A bus controller 1125 is provided for controlling bus 1130. An interrupt controller 1135 is used for receiving and processing various interrupt signals from the system components.

Mass storage may be provided by diskette 1142, CD or DVD ROM 1147, flash or rotating hard disk drive 1152. Data and software, including software 400 of the disclosure, may be exchanged with computer system 1000 via removable media such as diskette 1142 and CD ROM 1147. Diskette 1142 is insertable into diskette drive 1141 which is, in turn, connected to bus 1030 by a controller 11020. Similarly, CD ROM 1147 is insertable into CD ROM drive 1146 which is, in turn, connected to bus 1130 by controller 1145. Hard disk 1152 is part of a fixed disk drive 1151 which is connected to bus 1130 by controller 1150. It should be understood that other storage, peripheral, and computer processing means may be developed in the future, which may advantageously be used with the disclosure.

User input to computer system 1000 may be provided by a number of devices. For example, a keyboard 1156 and mouse 1157 are connected to bus 1130 by controller 1155. An audio transducer 1196, which may act as both a microphone and a speaker, is connected to bus 1130 by audio controller 1197, as illustrated. It will be obvious to those reasonably skilled in the art that other input devices, such as a pen and/or tablet, Personal Digital Assistant (PDA), mobile/cellular phone and other devices, may be connected to bus 1130 and an appropriate controller and software, as required. DMA controller 1160 is provided for performing direct memory access to RAM 1110. A visual display is generated by video controller 1165 which controls video display 1170. Computer system 1000 also includes a communications adapter 1190 which allows the system to be interconnected to a local area network (LAN) or a wide area network (WAN), schematically illustrated by bus 1191 and network 1195.

Operation of computer system 1000 is generally controlled and coordinated by operating system software, such as a Windows system, commercially available from Microsoft Corp., Redmond, Wash. The operating system controls allocation of system resources and performs tasks such as processing scheduling, memory management, networking, and I/O services, among other things. In particular, an operating system resident in system memory and running on CPU 1105 coordinates the operation of the other elements of computer system 1000. The present disclosure may be implemented with any number of commercially available operating systems.

One or more applications, such as an HTML page server, or a commercially available communication application, may execute under the control of the operating system, operable to convey information to a user.

All references cited herein are expressly incorporated by reference in their entirety. It will be appreciated by persons skilled in the art that the present invention is not limited to what has been particularly shown and described herein above. In addition, unless mention was made above to the contrary, it should be noted that all of the accompanying drawings are not to scale. There are many different features to the present invention and it is contemplated that these features may be used together or separately. Thus, the invention should not be limited to any particular combination of features or to a particular application of the invention. Further, it should be understood that variations and modifications within the spirit and scope of the invention might occur to those skilled in the art to which the invention pertains. Accordingly, all expedient modifications readily attainable by one versed in the art from the disclosure set forth herein that are within the scope and spirit of the present invention are to be included as further embodiments of the present invention.

What is claimed is:

1. A method for authenticating participants among a community of participants, comprising:
using at least one computer executing software stored on non-transitory media, the software configured to
store information pertaining to a plurality of participants, including an image of a first and second participant;
receive an image of the first participant, taken by the second participant;
compare the image of the first participant with the stored image of the first participant;
notify the second participant if the image of the first participant does not match the stored image of the first participant;
receive an image of the second participant, taken by the first participant;
compare the image of the second participant with the stored image of the second participant; and
notify the first participant if the image taken of the second participant does not match the stored image of the second participant.

2. A method for delivering packages among a community of participants, comprising:
using at least one computer executing software stored on non-transitory media, the software configured to
store information pertaining to a plurality of participants, including an image of participants who are senders, couriers, and receivers;
store information pertaining to a participant who is a sender of a package, a participant who is a receiver of the package, and a selection of a participant who is courier to deliver the package;
store information pertaining to the package, including a description of the contents of the package, a first geographic location where the courier is to pick up the package, and a second geographic location where the courier is to deliver the package;
receive a first image of the courier, the first image taken when the courier is physically in the presence of the sender to pick up the package;
compare the first image of the courier with a stored image of the courier among the images of participants;
notify at least one of the receiver and the seller if the first image of the courier does not match the stored image of the courier;
receive an image of the receiver, the image taken when the receiver and the courier are physically in each other's presence for the courier to deliver the package;
compare the image of the receiver with a stored image of the receiver among the images of participants;
notify at least one of the sender and the courier if the image taken of the receiver does not match the stored image of the receiver;
receive information pertaining to a delivery geographic location of the package when the package and the receiver and courier are mutually physically present for delivery of the package;
compare the delivery geographic location with the second geographic information; and
notify the sender if the delivery geographic location does not match the second geographic location.

3. The method of claim 1, wherein the software is further configured to:
receive an image of the sender when the courier is physically in the presence of the sender to pick up the package;
compare the image of the sender with a stored image of the sender among the images of participants; and
notify at least one of the courier and receiver if the image taken of the sender does not match the stored image of the sender.

4. The method of claim 2, wherein the software is further configured to:
receive a second image of the courier, the second image taken when the receiver and the courier are physically in each other's presence for the courier to deliver the package;
compare the second image of the courier with a stored image of the courier among the images of participants; and
notify at least one of the sender and the receiver if the second image of the courier does not match the stored image of the courier.

5. The method of claim 2, wherein the software is further configured to receive a first image of the contents of the package before the courier takes possession of the package for delivery.

6. The method of claim 5, wherein the software is further configured to:
receive a second image of the contents of the package when the receiver and the courier are physically in each other's presence for the courier to deliver the package; and
compare the first image of the contents with the second image of the contents and notify at least one of the sender and the receiver if the first and second images of the contents do not match.

7. The method of claim 5, wherein the first image of the contents of the package is received when the sender and the courier are physically in each other's presence for the courier to pick up the package.

8. The method of claim 2, wherein the software is further configured to:
receive a geographic pickup location of the package when the package is picked up by the courier for delivery;
receive a geographic delivery location of the package when the package is delivered to the receiver;
cause the geographic pickup and delivery locations to be available electronically by at least one of the sender and receiver.

9. The method of claim 2, wherein at least one of the geographic pick up and delivery locations are GPS coordinates.

10. The method of claim 8, wherein the software is further configured to compare the geographic pickup location with the stored first geographic location, and notify at least one of the sender and receiver if the geographic pickup location does not correspond to the first geographic location.

11. The method of claim 8, wherein the software is further configured to compare the geographic delivery location with the stored second geographic location, and notify at least one of the sender and receiver if the geographic delivery location does not correspond to the second geographic location.

12. The method of claim 2, wherein the software is further configured to debit an account of at least one of the sender and receiver for a fee for the courier to deliver the package.

13. The method of claim 12, wherein the fee for the courier is based upon the historical reliability of the courier in performing deliveries.

14. The method of claim 13, wherein the fee for the courier is further based upon the dimensions and weight of the package, and the distance over which the package must be delivered.

15. The method of claim 13, wherein the fee for the courier is further based upon the number of deliveries made by the courier.

16. The method of claim 15, wherein the fee for the courier is determined as a function of the historical reliability of the courier weighted by a factor, and the number of deliveries made by the courier, weighted by a factor.

17. The method of claim 2, wherein the stored image of participants is obtained from a digital image of an official identity card of the participant.

18. The method of claim 17, wherein the software is further configured to:
identify a plurality of facial features from the stored image of participants; and
compare the plurality of facial features with a plurality of facial features of other received images of the participants.

19. The method of claim 18, wherein the other received images of the participants include at least one of the first image of the courier, the image of the receiver, an image of the seller when the seller and the courier are physically mutually present, and an image of the receiver when the receiver and the courier are physically mutually present.

20. A system for delivering packages among a community of participants, comprising:
at least one computer executing software stored on non-transitory media, the computer including
a storage device for storing information pertaining to
a) a plurality of participants, including an image of participants who are senders, couriers, and receivers;
b) a participant who is a sender of a package, a participant who is a receiver of the package, and a selection of a participant who is courier to deliver the package; and
c) the package, including a description of the contents of the package, a first geographic location where the courier is to pick up the package, and a second geographic location where the courier is to deliver the package;
a network device for receiving
a) a first image of the courier, the first image taken when the courier is physically in the presence of the sender to pick up the package;
b) an image of the receiver, the image taken when the receiver and the courier are physically in each other's presence for the courier to deliver the package;
c) information pertaining to a delivery geographic location of the package when the package and the receiver and courier are mutually physically present for delivery of the package;
a processor for comparing
a) the first image of the courier with a stored image of the courier among the images of participants;
b) the image of the receiver with a stored image of the receiver among the images of participants;
c) the delivery geographic location with the second geographic information; and
a communication device for notifying
a) at least one of the receiver and the seller if the first image of the courier does not match the stored image of the courier;
b) at least one of the sender and the courier if the image taken of the receiver does not match the stored image of the receiver;
c) the sender if the delivery geographic location does not match the second geographic location.

21. A method for delivering packages among a community of participants, comprising:
using at least one computer executing software stored on non-transitory media, the software configured to
store information pertaining to a plurality of participants, including an image of participants who are senders, couriers, and receivers;
store information pertaining to a participant who is a sender of a package, a participant who is a receiver of the package, and a selection of a participant who is courier to deliver the package;
store information pertaining to the package, including a description of the contents of the package, a first image of the package contents, a first geographic location where the courier is to pick up the package, and a second geographic location where the courier is to deliver the package;
receive a first image of the courier, the first image taken when the courier is physically in the presence of the sender to pick up the package;
compare the first image of the courier with a stored image of the courier among the images of participants;
notify at least one of the receiver and the seller if the first image of the courier does not match the stored image of the courier;
receive an image of the receiver, the image taken when the receiver and the courier are physically in each other's presence for the courier to deliver the package;
compare the image of the receiver with a stored image of the receiver among the images of participants;
notify at least one of the sender and the courier if the image taken of the receiver does not match the stored image of the receiver;
receive a second image of the contents of the package, the image taken when the receiver and the courier are physically in each other's presence for the courier to deliver the package;
compare the stored first image of the package contents with the second image of the package contents;
notify at least one of the sender, the courier, and the receiver if the first image of the package contents does not match the second image of the package contents;
receive information pertaining to a delivery geographic location of the package when the package and the receiver and courier are mutually physically present for delivery of the package;
compare the delivery geographic location with the second geographic information; and
notify the sender if the delivery geographic location does not match the second geographic location.
